(19) United States
(12) Patent Application Publication
(10) Pub. No.: US 2009/0283360 A1
(43) Pub. Date: Nov. 19, 2009

(54) Safety Pole for Handicapped Persons

(76) Inventor: George H. Eckerdt, Fishers, NY (US)

Correspondence Address: BROWN & MICHAELS, PC;400 M & T BANK BUILDING, 118 NORTH TIOGA ST, ITHACA, NY, 14850, US

(21) Appl. No.: 12/254,996

(22) Filed: Oct. 21, 2008

Related U.S. Application Data
(63) Continuation-in-part of application No. 11/420,637, filed on May 26, 2006, now abandoned.
(60) Provisional application No. 60/685,454, filed on May 27, 2005.

(51) Int. Cl. A61H 3/00

(52) U.S. Cl. 182/100

(57) ABSTRACT

A handicap assister includes an upright support extending upward to a ceiling from a floor mount for a base and a rotating foot platform. The upright support can include a pole telescoped within a sleeve arranged on an axis of rotation of the platform. A hand grip region or handle is arranged at about eye level to a person sitting next to the platform so that a user can place feet on the platform and use the hand grip to rise from a seated position to a standing one, can then rotate around the upright support, and can use the hand grip to help lower back into a seated position. This allows movement between a bed and a wheelchair and between a wheelchair and a bed or toilet.

### RELATED APPLICATIONS

This application is a continuation-in-part of parent patent application Ser. No. 11/420,637, filed 26 May 2006, abandoned with the filing of this application. Parent patent application is the non-provisional application to provisional application No. 60/685,454, filed 27 May 2005, entitled “Safety Pole for Handicapped Persons”.

### FIELD OF THE INVENTION

Handicapped assistance poles.

### BACKGROUND

The many suggestions for poles and hand grips to assist handicapped people have several shortcomings. They tend to require involvement of a care giver and do not fully exploit the capacities that remain available to many users. Many of the problems faced by handicapped people are getting from a wheelchair into bed, from bed into a wheelchair, from a wheelchair to a toilet, and vice versa. The invention aims at a more ergonomically successful handicapped assister to help solve these problems.

### SUMMARY

The invention involves a rotating foot platform and an upright support. The upright support, which can be a single pole or a combination of a pole and a sleeve, is made solid and stable by connecting between a floor and ceiling. This extends the pole on a vertical axis of rotation of the foot support platform and ensures that any side load applied to the pole cannot move it laterally from its fixed position. Since both a pole and a sleeve surrounding a portion of the pole can be involved in the upright support, there are several preferred ways of holding the upright support to the vertical axis of the rotating foot platform.

The upright support also affords a hand grip region at about eye level to a person sitting near the foot platform. This allows a sitting person to grasp the hand grip region and use arm strength to help in rising from a sitting to a standing position on the rotatable foot platform. Conversely, a person standing on the platform can grasp the handgrip region and use arm strength to help lower herself to a sitting or reclining position. For these purposes, the upright support and the rotating foot platform are preferably arranged near a bed, toilet, or lounge chair so that a handicapped person can move successfully between these locations and a wheelchair.

### DRAWINGS

FIG. 1 shows a partially cross-sectioned schematic view of a preferred embodiment of the invention.

FIGS. 2A and 2B show perspective views of the invention of FIG. 1.

FIGS. 3A and 3B show perspective views of a seated person using the invention of FIGS. 1 and 2.

FIGS. 4A and 4B show perspective views of a standing person using the invention of FIGS. 1 and 2.

FIG. 5 is a partially schematic view of a pole and sleeve combination affording an upright support extending between a ceiling and a rotatable foot platform.

FIG. 6 is a partially schematic view, similar to FIG. 5, showing an upright support as a single pole connected between a ceiling and a base for a rotating foot platform.

### DETAILED DESCRIPTION

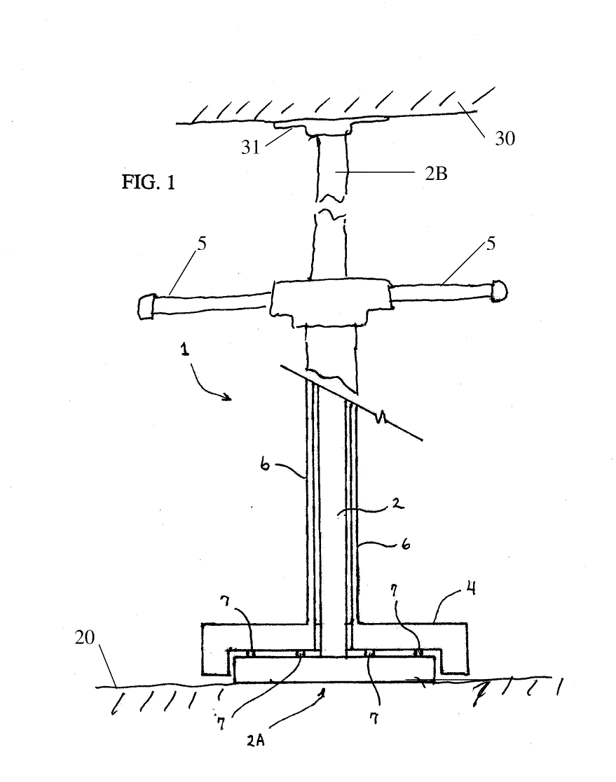

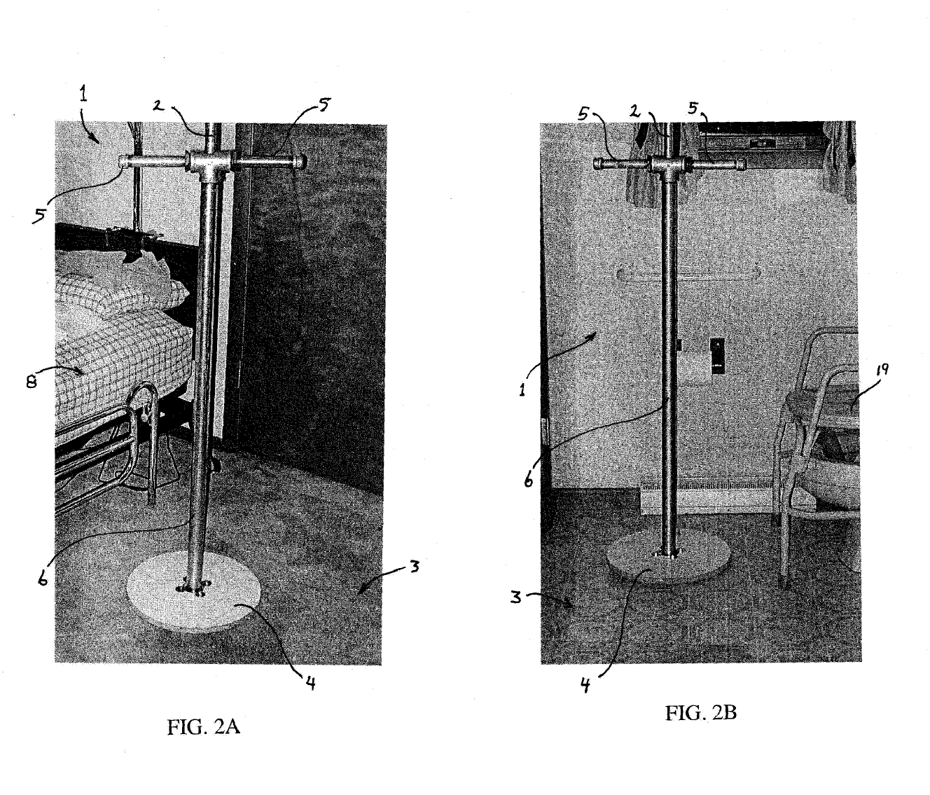

The handicap assistance device 1 includes an upright support pole 2 having a base end 2A for location adjacent a floor 3. Pole 2 can have a telescoping upper section 2B that can be pressed upward firmly against a ceiling so as to from a stable frictional fit and hold pole 2 in rigid position between floor 3 and a ceiling. Better yet, flange 31 or some other coupling can connect an upper end of pole 2B to ceiling 30, as schematically shown in FIG. 1. Many alternatives can accomplish the preferred connection of pole 2B to ceiling 30.

As schematically shown in FIG. 1, base 2A is preferably fixed to floor 20 and to a lower end of pole 2. Bearings 7 such as used in turntables or “lazy susan” devices allow platform 4 to rotate freely while supporting the weight of a person standing on platform 4.

Support pole 2 affords a hand grip at about eye level to a seated person, and the hand grip can be provided by the pole itself. In a preferred embodiment, a handle or handles 5 offer the necessary hand grip. A preferred way of providing handles 5 is to mount them at an upper region of a sheath or sleeve 6 that surrounds pole 2 and connects to foot platform 4. This is mounted on base 2A so that platform 4 rotates around the vertical axis of pole 2. Base 2A, pole 2, rotating platform 4, and sleeve 6 are held to the vertical axis of pole 2 while allowing platform 4 to rotate. A lower region of sleeve 6 preferably connects to platform 4 so that sleeve 6 and handles 5 rotate with platform 4. An upper region of sleeve 6 can also afford the necessary hand grip, but handles 5, added to sleeve 6, are preferred as ergonomically convenient.

The hand grip region provided by pole 2 or sleeve 6 or handle 5 is preferably located above platform 4 at about eye level to a person seated next to platform 4. Then a seated user can reach up to handle 5 or a hand grip region to use some arm strength in rising from a seated to a standing position on platform 4. Once a person is standing on platform 4 and gripping handle 5, the person can easily be rotated around the pole to move from one seated position to another, as from a wheelchair to a bed or toilet and back to a wheelchair. Handle 5 or a corresponding hand grip region not only helps a person rise to a standing position on platform 4, but also helps the person lower safely from a standing position to a seated position. While standing, the user can readily rotate around pole 2 since platform 4 and sleeve 6 turn on bearings 7, which assure easy rotational movement.

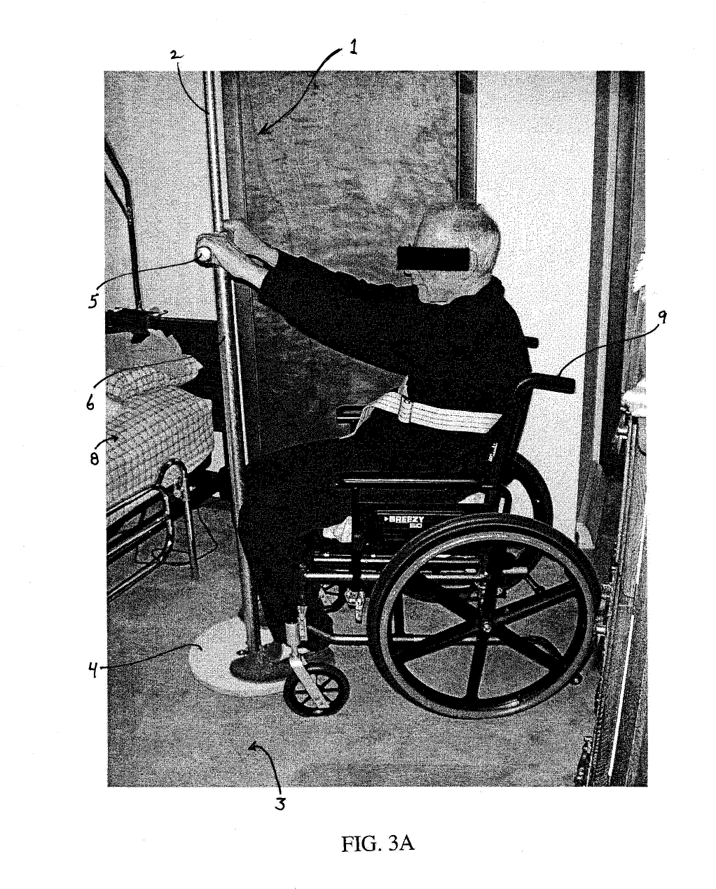

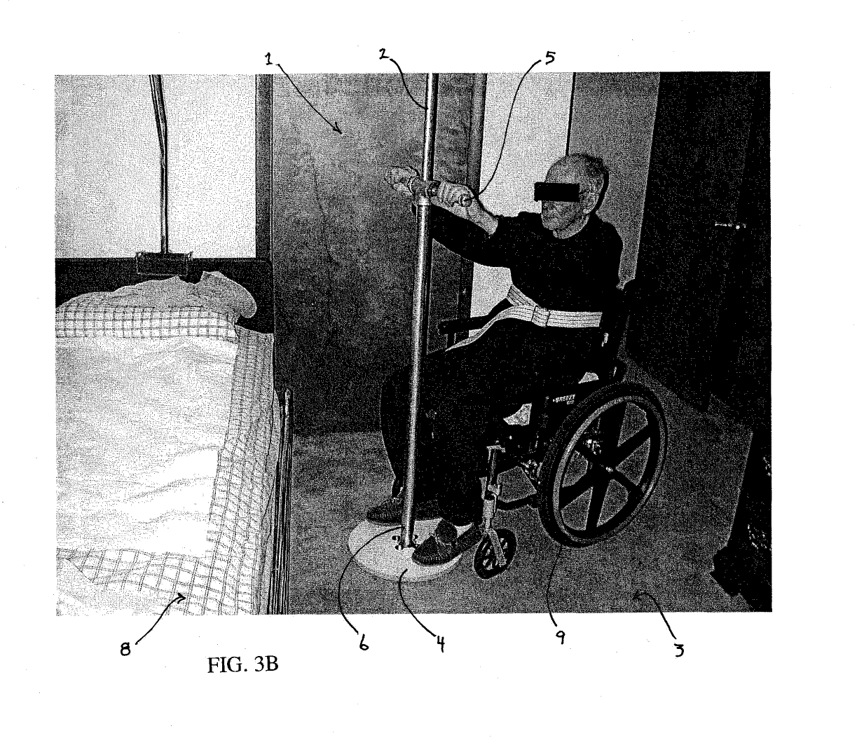

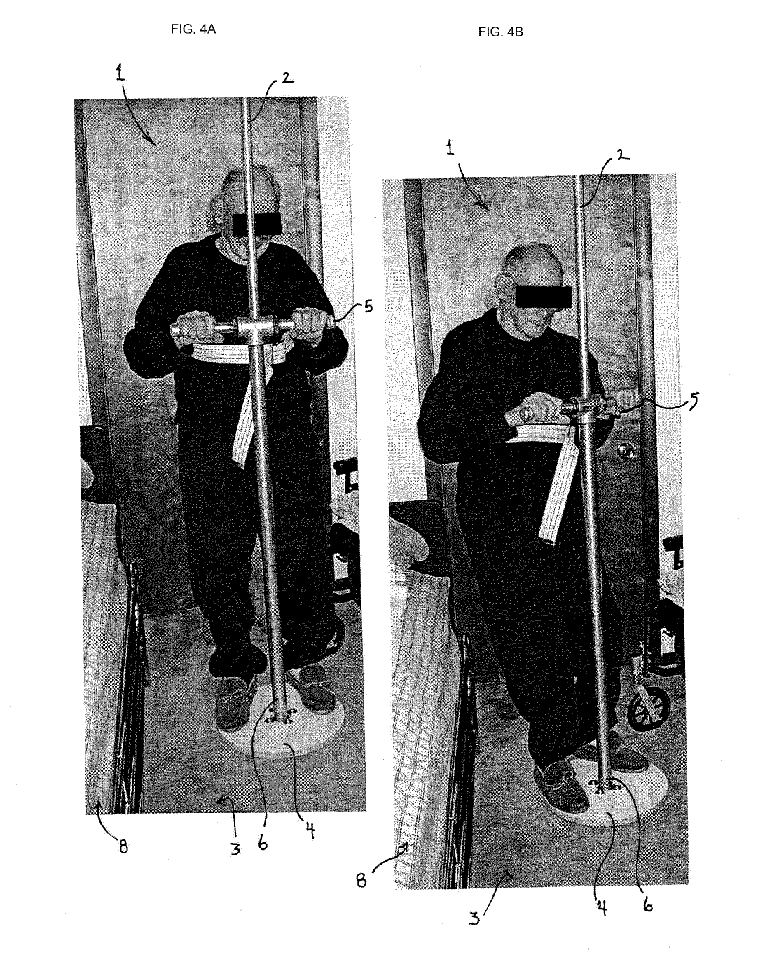

This sequence is illustrated in FIGS. 3A through 4B. In these drawings, a disabled user is illustrated with feet and hands applicably placed on the upright support and (a) ready to rise from wheelchair 9 in FIGS. 3A and 3B, (b) beginning the process of rotating around pole 2 in FIG. 4A, and (c) further rotated around pole 2 and/or ready to be seated on bed 8 in FIG. 4B. Alternately, starting at the other end of the sequence, a disabled user is illustrated with feet and hands suitably placed and (a) holding onto the handles 5 after rising from bed 8 in FIG. 4B, (b) in the process of being rotated around pole 2 in FIG. 4, and (c) after settling into wheelchair 9 in FIGS. 3A and 3B.

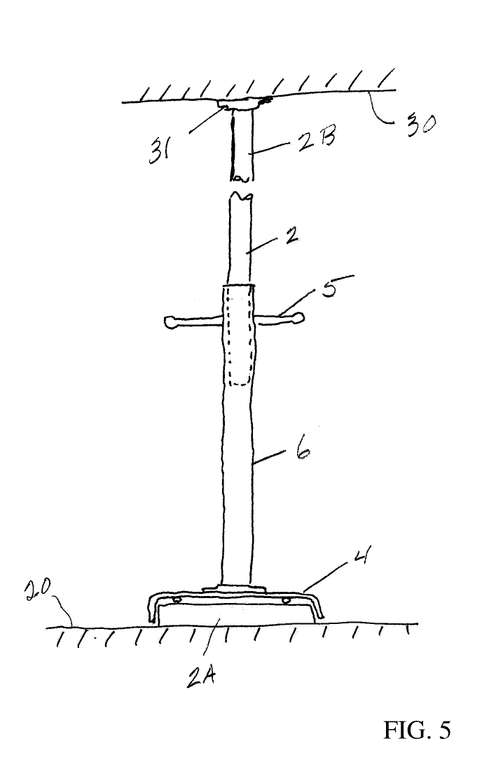

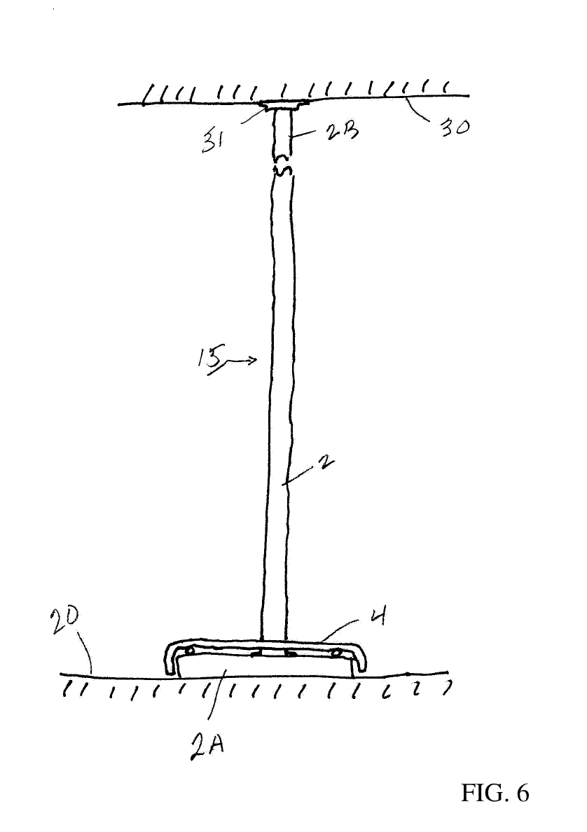

The many alternatives that are possible in structuring the inventive assistance device are suggested in FIGS. 5 and 6. In FIG. 5, for example, pole 2 extends from its ceiling attached upper end 2B down into a telescoping fit within the upper end of sleeve 6 without extending all the way down to foot platform 4 or base 2A. Sleeve 6 is preferably connected to and rotates with foot platform 4, which is held to the vertical axis of pole 2 by base 2A, which is attached to floor 20. This advantageously allows sleeve 6 and its handles 5 to rotate with platform 4. It also uses a shorter length of pole 2, and the combination of pole 2 and sleeve 6 form an upright support that is solidly held to a vertical axis by the connections to floor and ceiling.

FIG. 6 schematically illustrates a further simplification with sleeve 6 omitted, and pole 2 extending from base 2A on floor 20 to connector 31 at ceiling 30. A hand grip region 15 of pole 2 is then available at about eye level to a seated person, and the connections at upper and lower ends of pole 2 assure that it is securely held on the vertical rotational axis of foot platform 4.

What is claimed is:

1. An assister for handicapped persons, the assister comprising:
a rotatable foot platform having a fixed vertical axis of rotation;
an upright support fixed to a ceiling and extending downward along the fixed axis of rotation of the foot platform; and
the upright support affording a hand grip region located at about eye level to a person sitting near the platform so that the person can position feet on the platform and reach up to grasp the hand grip region and use arms to help rise to a standing position on the platform whereupon the platform and the person standing on the platform can be rotated around the upright support.

2. The assister of claim 1 wherein the upright support is a single pole extending between the ceiling and a floor connection under the platform.

3. The assister of claim 1 wherein the upright support comprises a pole and a sleeve that surrounds a lower region of the pole.

4. The assister of claim 3 wherein the sleeve is fastened to the platform.

5. The assister of claim 4 wherein the sleeve extends to the hand grip region and supports a handle at the hand grip region.

6. The assister of claim 1 wherein the upright support comprises a pole extending downward from the ceiling and a sleeve extending upward from the platform to surround a lower region of the pole.

7. The assister of claim 6 wherein the hand grip region comprises a handle on an upper region of the sleeve.

8. An assister for handicapped persons, the assister comprising:
an upright support arranged on a vertical axis extending between a floor and a ceiling;
top and bottom regions of the upright support being fixed on the vertical axis;
a rotatable foot platform arranged to rotate around a floor end region of the vertical axis; and
a hand grip region arranged on the upright support at about eye level to a user sitting near the platform helps the user to move between sitting next to the platform and standing on the platform and to turn from one position near the upright support to another position near the upright support.

9. The assister of claim 8 wherein the upright support is a pole extending between the ceiling and a floor connection under the platform.

10. The assister of claim 8 wherein the upright support comprises a pole extending downward from the ceiling and a sleeve extending upward from the platform so that the sleeve surrounds a lower region of the pole.

11. The assister of claim 10 wherein the hand grip region is provided by the sleeve.

12. The assister of claim 10 wherein the bottom region of the pole connects to a base under the platform, and the sleeve connects to the platform.

13. A combination arranged to help a handicapped person move from one position to another, the combination including a rotatable foot supporting platform, and the combination comprising:
an upright support fixed at lower and upper regions respectively between a floor and a ceiling so that the upright support is held to a vertical axis of rotation of the platform;
the upright support providing a hand grip region arranged at about eye level to a person sitting near the platform;
the upright support comprising a pole extending downward from the ceiling and a sleeve extending upward from the platform to surround a lower portion of the pole; and
the platform and the upright support being arranged to assist a handicapped person to move between sitting positions adjacent the platform and standing positions on the platform.

14. The combination of claim 13 wherein the sleeve is connected to the platform.

15. The combination of claim 13 wherein a base supports the platform and the platform rotates around the upright support.

16. The combination of claim 13 wherein the bottom region of the pole connects to a base under the platform and the sleeve connects to the platform.
